(19) United States
(12) Patent Application Publication
(10) Pub. No.: US 2007/0019105 A1
(43) Pub. Date: Jan. 25, 2007

(54) Imaging apparatus for performing optimum exposure and color balance control

(75) Inventor: Masaharu Yanagidate, Sagamihara-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 11/476,711

(22) Filed: Jun. 29, 2006

(30) Foreign Application Priority Data
Jul. 6, 2005 (JP) 2005-197611

(51) Int. Cl. H04N 5/235

(52) U.S. Cl. 348/362

(57) ABSTRACT

An imaging apparatus includes an imaging device outputting original image data; an electronic zoom device for subjecting data of a predetermined first image area among the original image data to electronic zooming; a parameter operation circuit for respectively multiplying evaluation coefficients by image data belonging to the first image area and image data belonging to a second image area other than the first image area with respect to the original image data, so as to compute a parameter used for at least one of exposure control and color balance control; and a control circuit for applying a zoom area preference evaluation mode to the parameter operation circuit, so as to set the evaluation coefficient assigned to the first image area to a larger value in comparison with the evaluation coefficient assigned to the second image area.

### BACKGROUND OF THE INVENTION

1. Field of the Invention

The present invention relates to an imaging apparatus, in particular, relates to exposure control and color balance control of an imaging apparatus which has an electronic zoom function.

Priority is claimed on Japanese Patent Application No. 2005-197611, filed Jul. 6, 2005, the content of which is incorporated herein by reference.

2. Description of the Related Art

Some imaging apparatuses have an electronic zoom function in which image data in a zoom area is extracted from among the overall image data output from an imaging device, and interpolation between pixels in the zoom area is performed so as to generate new pixels and to perform image expansion. An imaging apparatus having such an electronic zoom function has been proposed in which imaging and display in an electronic zoom state are performed during imaging operation; however, all image data output from the imaging device is used as data to be stored, and stored data is subjected to trimming so as to obtain an image with a desired angle (i.e., area) of view.

For example, Reference Document 1 (Japanese Unexamined Patent Application, First Publication No. H10-233950) discloses two kinds of methods for producing data to be stored: a first method of using an image, which has been subjected to interpolation transformation and electronic zoom processing, as such data to be stored, and a second method of outputting the whole of a received image (i.e., an image before being subjected to interpolation transformation) and trimming the output data with a desired zoom magnification.

This Reference Document 1 also discloses a method using an apparatus which has a fixed-focal-length image input optical system having a function of compressing a peripheral portion of an input image, and a light receiving element (having a uniform pixel density) for receiving the input image, wherein the apparatus has a function of correcting and transforming a received image which includes distortion due to the compression by the input optical system, thereby realizing a zoom image having a resolution substantially equal to that obtained when no compression is performed.

On the other hand, Reference Document 2 (Japanese Unexamined Patent Application, First Publication No. 2001-116978) discloses a technique relating to automatic exposure (AE) control and automatic white balance (AWB) correction in imaging in an electronic zoom state and discloses a method of performing processing only using image data in an electronic zoom area so as to optimize an image in the electronic zoom area.

### SUMMARY OF THE INVENTION

The present invention provides an imaging apparatus comprising:

an imaging device outputting original image data;

an electronic zoom device for subjecting data of a predetermined first image area among the original image data to electronic zooming;

a parameter operation circuit for respectively multiplying evaluation coefficients by image data belonging to the first image area and image data belonging to a second image area other than the first image area with respect to the original image data, so as to compute a parameter used for at least one of exposure control and color balance control; and

a control circuit for applying a zoom area preference evaluation mode to the parameter operation circuit, so as to set the evaluation coefficient assigned to the first image area to a larger value in comparison with the evaluation coefficient assigned to the second image area.

In a typical example, the control circuit controls the parameter operation circuit so that a larger number of image data items is obtained by sampling of the first image area in comparison with the number of image data items obtained by sampling of the second image area.

Preferably, the control circuit can apply a whole area uniform evaluation mode to the parameter operation circuit, so as to set the evaluation coefficients assigned to the first image area and the second image area to substantially the same value, and either of the whole area uniform evaluation mode or the zoom area preference evaluation mode is selectable.

The present invention also provides an imaging apparatus comprising:

a distortion optical system having an optical characteristic for condensing light while compressing a peripheral area of a subject to be photographed in comparison with a central area of the subject.

an imaging device for converting an optical image obtained by imaging of the distortion optical system to image data;

a parameter operation circuit for performing an operation for computing a parameter used for exposure control with respect to the subject, based on the image data output from the imaging device and the optical characteristic of the distortion optical system;

an image processing circuit for subjecting the image data, which is obtained by imaging performed after the exposure control, to image processing in accordance with the optical characteristic, based on the computed parameter; and

a control circuit having a plurality of selectable exposure modes, and determining the operation executed by the parameter operation circuit and the image processing executed by the image processing circuit in accordance with the selected exposure mode.

In a typical example, the control circuit has a person mode as one of the exposure modes, and when the person mode is selected:

the parameter operation circuit executes the operation for computing the parameter based on a first average exposure obtained using the image data belonging to the central area and a second average exposure obtained using the image data belonging to the peripheral area, while applying a larger weight to the first average exposure in comparison with the second average exposure; and

the image processing circuit executes the image processing of the image data belonging to the peripheral area, based on a quantity of received light of the central area.

In another typical example, the control circuit has a night-view mode as one of the exposure modes, and when the night-view mode is selected:

the parameter operation circuit executes the operation for computing the parameter so as to set a peak quantity of received light with respect to the image data to a value within a predetermined range; and

the image processing circuit executes the image processing of the image data belonging to the central area, based on a quantity of received light of the peripheral area.

In a preferable example, the imaging apparatus further comprises:

an electronic zoom device for subjecting data of a predetermined image area among the image data to electronic zooming, wherein:

the parameter operation circuit computes the parameter, in an electronic zoom operation mode, by multiplying a first evaluation coefficient by image data, which belongs to a first image area subjected to the electronic zooming, among the image data, and also multiplying a second evaluation coefficient smaller than the first evaluation coefficient by image data, which belongs to a second image area other than the first image area, among the image data;

the control circuit has a person mode and a night-view mode as the selectable exposure modes;

when the person mode is selected, the parameter operation circuit executes the electronic zoom operation mode, and the image processing circuit executes the image processing of the image data belonging to the peripheral area, based on a quantity of received light of the central area; and

when the night-view mode is selected, the parameter operation circuit executes the operation for computing the parameter so as to set a peak quantity of received light with respect to the image data to a value within a predetermined range, and the image processing circuit executes the image processing of the image data belonging to the central area, based on a quantity of received light of the peripheral area.

### BRIEF DESCRIPTION OF THE DRAWINGS

FIG. 1 is a block diagram showing the structure of an imaging apparatus of the first embodiment in accordance with the present invention.

FIG. 2 is a diagram explaining the zoom area defined in electronic zooming.

FIG. 3 is a flowchart showing the finder operation in the first embodiment.

FIG. 4 is a flowchart showing the capture operation in the first embodiment.

FIG. 5 is a flowchart showing the AE/AWB preprocess in the first embodiment.

FIG. 6 is a diagram showing a sampling state of data for operation in the zoom area preference evaluation mode.

FIG. 7 is a diagram showing a sampling state of data for operation in the whole area uniform evaluation mode.

FIG. 8 is a flowchart showing the AE process in the first embodiment.

FIG. 9 is a flowchart showing the AE evaluation operation in the first embodiment.

FIG. 10 is a flowchart showing the AWB process in the first embodiment.

FIG. 11 is a diagram showing the lens configuration of a distortion lens unit of the second embodiment in accordance with the present invention.

FIG. 12 is a diagram for explaining the characteristics of the distortion lens unit in FIG. 11.

FIG. 13 is also a diagram for explaining the characteristics of the distortion lens unit in FIG. 11.

FIG. 14 is a diagram showing a distribution of the quantity of light when uniform light is received in the imaging apparatus using the distortion lens unit in FIG. 11.

FIG. 15 is a graph showing the characteristics of the quantity of received light when uniform light is received in the imaging apparatus using the distortion lens unit in FIG. 11.

FIG. 16 is a diagram showing an example of the area division based on the quantity of light.

FIG. 17 is a flowchart showing the capture operation in the second embodiment.

FIG. 18 is a flowchart showing the AE process in the second embodiment.

FIG. 19 is a flowchart showing the AE evaluation operation of the person mode in the second embodiment.

FIG. 20 is a flowchart showing the AE evaluation operation of the night-view mode in the second embodiment.

FIG. 21 is a diagram for explaining the person mode and the night-view mode.

FIG. 22 is a waveform diagram showing outputs of the imaging device in the night-view mode.

FIG. 23 is a waveform diagram showing outputs of the imaging device in the person mode.

FIG. 24 is a waveform diagram showing data output levels after the correction of the quantity of light in the night-view mode.

FIG. 25 is a waveform diagram showing data output levels after the correction of the quantity of light in the person mode.

FIG. 26 is a flowchart showing the AE evaluation operation of the person mode in the third embodiment in accordance with the present invention.

### DESCRIPTION OF THE PREFERRED EMBODIMENTS

Hereinafter, embodiments in accordance with the present invention will be described with reference to the appended figures.

### First Embodiment

In this embodiment, the present invention is applied to an imaging apparatus having an electronic zoom function for imaging operation, in which electronic zooming is performed during imaging, and the whole image obtained by the imaging is output as data to be stored.

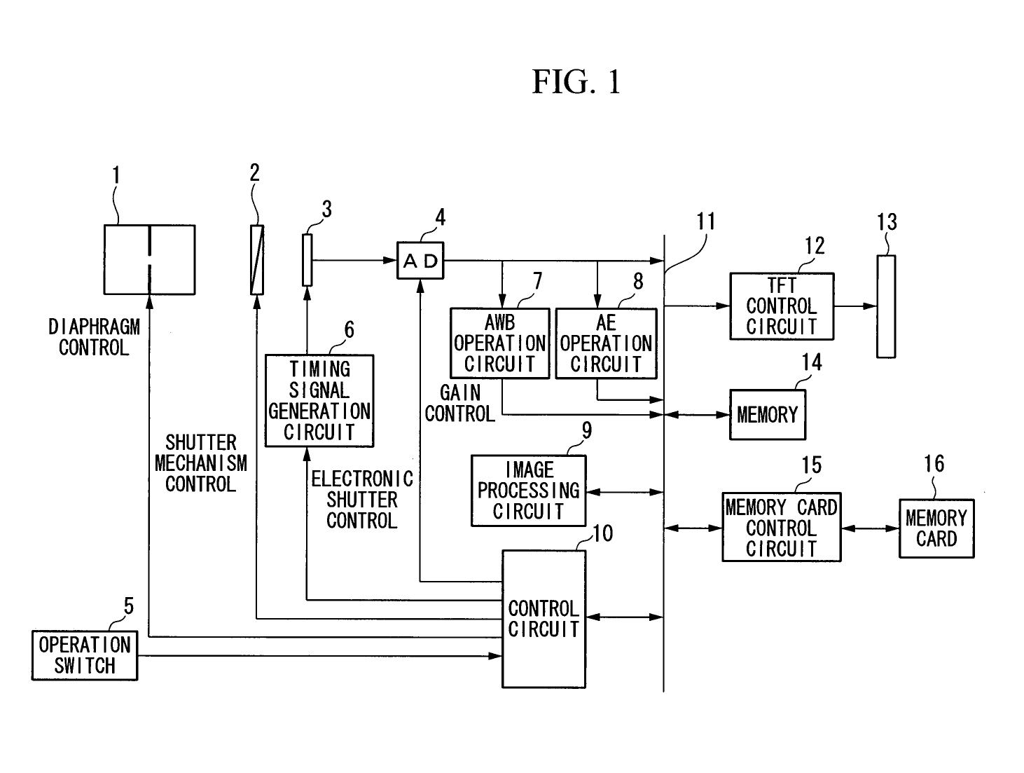

FIG. 1 is a block diagram showing the structure of an imaging apparatus of the first embodiment of the present invention. First, the general operation of this imaging apparatus will be explained.

In FIG. 1, a lens unit 1 has an ordinary single-vision (or single focus) lens, and light condensed by the lens unit 1 is imaged via a shutter mechanism 2 onto an imaging device 3 (i.e., a CCD (charge coupled device)).

The imaging device 3 is controlled at a desired control timing in accordance with a control signal output from a timing signal generation circuit 6. The control timing provided by the timing signal generation circuit 6 is known by referring to a known method of controlling a CCD; thus, explanation thereof is omitted here.

Each signal output from the imaging device 3 is converted into digital data by an AD (analog to digital) conversion circuit 4, and is output onto a data bus 11. The AD conversion circuit 4 also performs color balance control by respectively making R (red), G (green), and B (blue) analog signals, which are output from the imaging device 3, pass through amplification circuits assigned to the colors, while controlling an amplification ratio (or factor) of the amplification circuit of each color. In addition, image data after the digital conversion is subjected to buffering for temporal conversion, and converted data is output to the data bus 11.

The image data output from the AD conversion circuit 4 is also input into an AWB operation circuit 7 and an AE operation circuit 8. The AWB operation circuit 7 and the AE operation circuit 8 obtain desired image data in accordance with necessity, and execute operations for color balance control and exposure control.

In imaging operation, the image data on the data bus 11 is stored in a memory 14, and then converted into a brightness element (called “Y”) and color elements (called “Cr, Cb”) (this conversion is called “YC conversion”). The converted data is then subjected to JPEG (joint photographic experts group) compression and then stored in a memory card 16 via a memory card control circuit 15.

The electronic zoom process applied to the data to be stored is performed by an image processing circuit 9, together with a process of changing the data area to which C conversion is applied. A detailed explanation of the electronic zoom process will be provided later.

In finder display operation, the image data on the data bus 11 is stored in the memory 14 and then subjected to YC conversion executed by the image processing circuit 9, thereby generating data to be displayed, which is also stored in the memory 14. The data to be displayed, stored in the memory 14, is appropriately read out, and readout data is displayed via a liquid crystal (TFT) control circuit 12 on a liquid crystal display device 13 (i.e., a TFT).

An electronic zoom process applied to the image data for the finder (display) is also performed by the image processing circuit 9, and the data to be displayed, having a desired zoom ratio, is produced in accordance with a designating operation. The operation of an operation switch 5 (operated by the photographer or the like) is detected by a control circuit 10, and control in accordance with the detected operation is applied to each circuit by the control circuit 10.

In exposure control operation, the control circuit 10 computes a control value (as a parameter used for control) by using the result of the operation output from the AE operation circuit 8. Based on the computed control value, the control circuit 10 controls the position of a diaphragm in a diaphragm mechanism of the lens unit 1, shutter speed of the shutter mechanism 2, and electronic shutter speed set in the timing signal generation circuit 6, thereby controlling the quantity of light on the imaging device 3.

In color balance control, the control circuit 10 computes a control value (as a parameter used for control) by using the result of the operation output from the AWB operation circuit 7. Based on the computed control value, the control circuit 10 controls the amplification ratio of the amplification circuit of each color in the AD conversion circuit 4, thereby controlling the color balance of the image data after digital conversion.

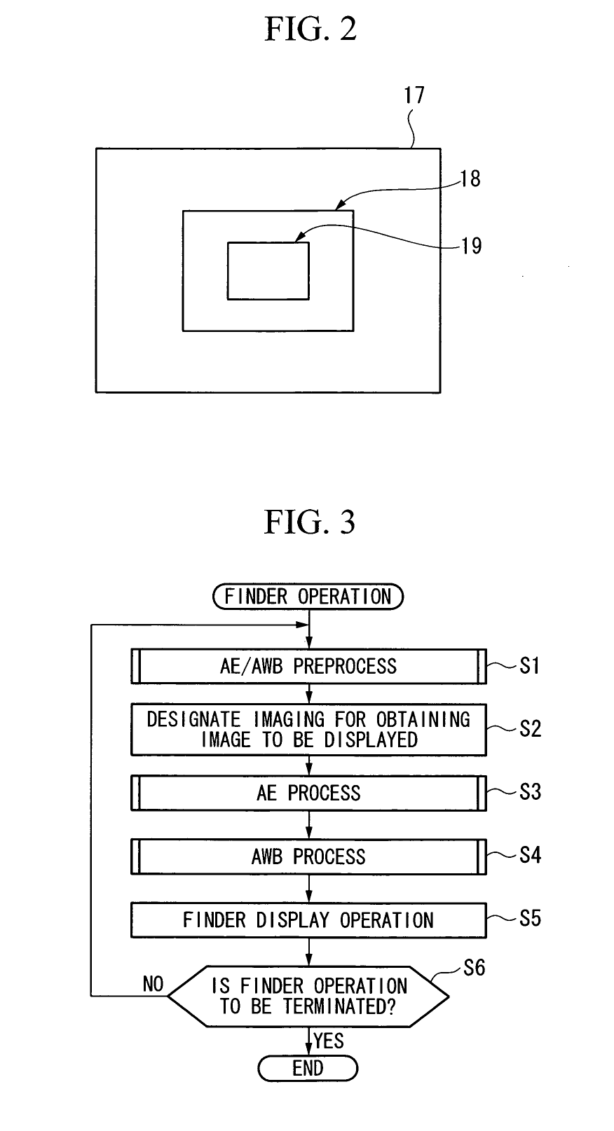

The electronic zoom function of the present embodiment will been explained with reference to FIG. 2. Electronic zooming includes extracting image data belonging to a zoom area from among the whole image, generating new pixels by subjecting pixels in the zoom area to interpolation, and displaying an image enlarged to have a size of the whole image.

FIG. 2 shows a whole area 17 of a present image, a 2× zoom area 18, and a 3× zoom area 19. In a 133 mode, the image of the whole area 17 is simply used for display. In a 2× zoom mode, the image belonging to the zoom area 18 is extracted, and pixels of the extracted image are interpolated so as to produce an enlarged image corresponding to the whole area. In a 3× zoom mode, the image belonging to the zoom area 19 is extracted, and pixels of the extracted image are interpolated so as to produce an enlarged image corresponding to the whole area.

In the present embodiment, when the electronic zoom operation (i.e., electronic zooming) is performed in the finder display operation, the image in the relevant zoom area is interpolated, and an enlarged imaged is then displayed in the liquid crystal display device 13. For example, in 2× zoom, the image in the zoom area 18 is interpolated, and an obtained enlarged image is displayed as a finder image on the liquid crystal display device 13. On the other hand, in 3× zoom, the image in the zoom area 19 is interpolated, and an obtained enlarged image is displayed as a finder image on the liquid crystal display device 13.

In contrast, when a capture operation (i.e., pushing down the shutter button) is performed during electronic zooming, stored in the memory card 16 as a capture image is an image corresponding to all effective pixels of the imaging device 3, regardless of the state of electronic zooming. That is, even in 2× zoom or 3× zoom, the whole image in the whole area 17 is stored, wherein the fact that the image was obtained in an electronic zoom state is stored as additional data.

Therefore, in the present embodiment, the method for exposure and color balance control can be switched depending on (i) the first case in which a particularly important image is present in the zoom area, or (ii) the whole image is important. The control circuit 10 performs control necessary for the switching. That is, the control circuit 10 has a zoom area preference evaluation mode in which priority is given to control in the zoom area, and a whole area uniform evaluation mode in which control is performed in consideration of the whole image to be stored. The evaluation mode can be selected manually by the photographer.

Next, exposure control and color balance control in the first embodiment will be explained in detail with reference to FIGS. 3 to 10.

The exposure control and the color balance control are performed in a period from when the apparatus enters the imaging state to when the composition (for the image) is determined, and also performed both (i) in the finder operation in which a finder image is displayed on the liquid crystal display device 13, and (ii) in the capture operation in which, after the shutter button is pushed down, image data is read out from the imaging device 3 and stored in a storage medium.

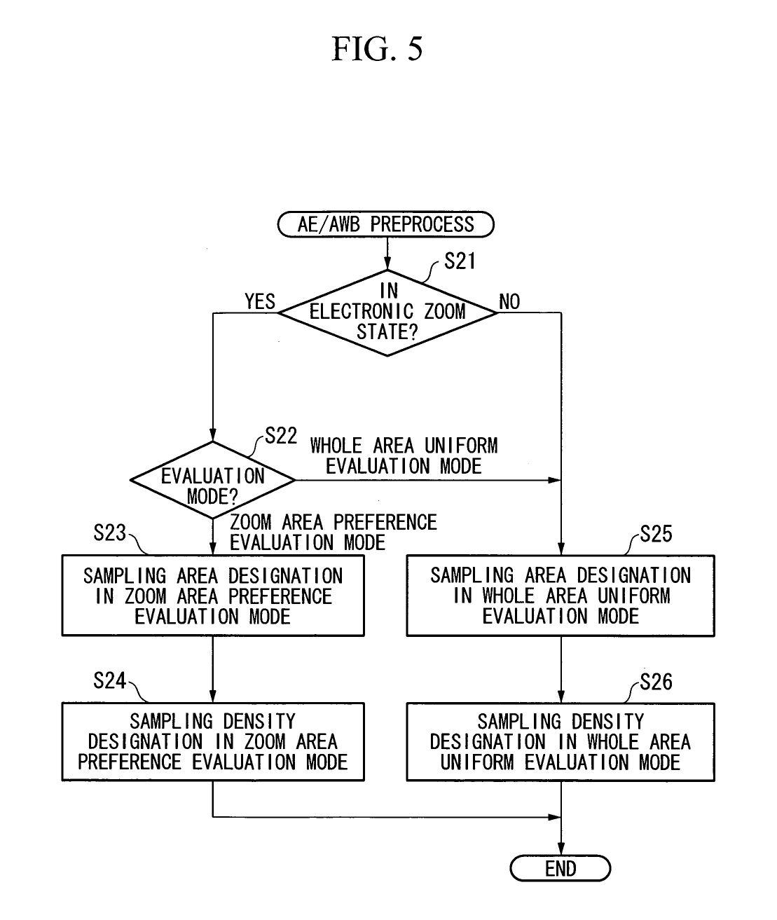

FIG. 3 is a flowchart explaining the finder operation. In FIG. 3, when the finder operation is started, the control circuit 10 first executes an AE/AWB preprocess subroutine for designating the contents of operation of the AWB operation circuit 7 and operation of the AE operation circuit 8 (see step S1). More specifically, the AE/AWB preprocess is performed for designating an area and a position of image data used in AE/AWB operation processes, a detailed explanation of which will be provided later with reference to FIG. 5.

In the next step S2, imaging for obtaining an image to be displayed is designated. That is, in step S2, when such imaging has not yet been started, the timing signal generation circuit 6 is controlled so as to drive the imaging device 3 in a desired state and to open the shutter mechanism 2, thereby starting the imaging for obtaining the image to be displayed. As described above, the image data from the imaging device 3 is input not only into the AWB operation circuit 7 and the AE operation circuit 8, but also into the memory 14.

In the next step S3, an operation for exposure is executed in an AE process, and based on the results of the operation, the diaphragm position of the diaphragm mechanism in the lens unit 1, and the electronic shutter speed set in the timing signal generation circuit 6 are controlled, thereby performing exposure control.

In the next step S4, a color balance measuring operation is performed in an AWB process, and based on the results of the operation, the amplification ratio of the amplification circuit of each color in the AD conversion circuit 4 is controlled, thereby controlling the color balance.

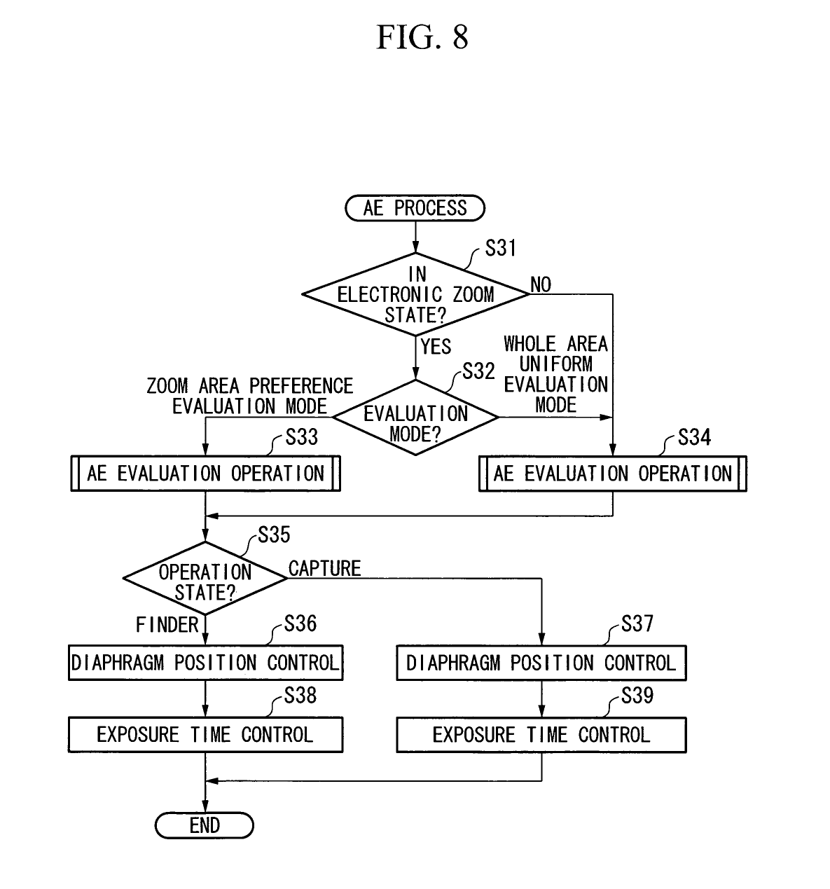

A detailed explanation of the exposure control and the color balance control will be provided later with reference to FIGS. 8 to 11.

In the finder display process, the image data stored in the memory 14 is read out and input into the image processing circuit 9 so as to convert the data into data to be displayed on the finder, and the converted data is again stored in the memory 14 (see step S5). The liquid crystal (TFT) control circuit 12 reads out the data to be displayed on the finder, and displays the data as a finder image on the liquid crystal display device 13.

After that, the state of the operation switch 5 is checked so as to determine whether the finder operation is continued (see step S6). When the finder operation is to be continued, the operation proceeds to step S1 for executing the AE/AWB preprocess subroutine, while when the finder operation is to be terminated, a specific ending process is performed.

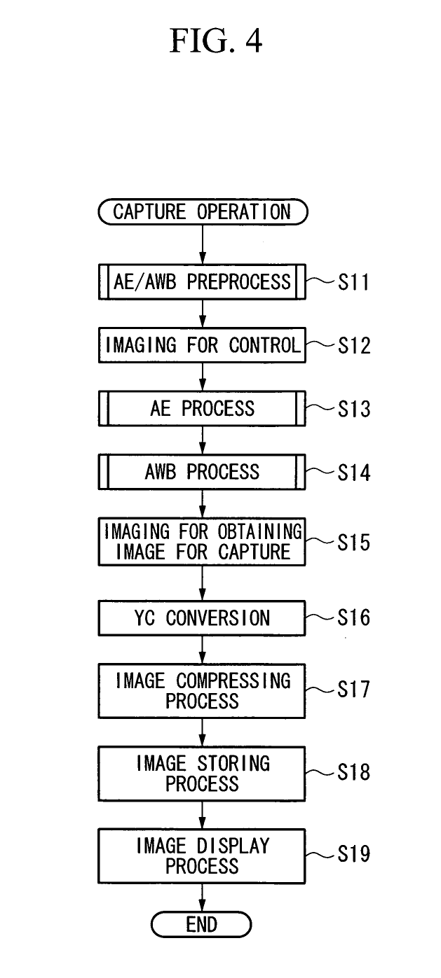

FIG. 4 is a flowchart explaining the capture operation. In FIG. 4, when the capture operation is started, the control circuit 10 executes the AE/AWB preprocess subroutine, similar to the finder operation (see step S11).

In the next step S12, imaging for control is performed by controlling the timing signal generation circuit 6 so as to drive the imaging device 3. Image data obtained in this imaging is input into the AWB operation circuit 7 and the AE operation circuit 8 so as to respectively execute specific operations. The image data obtained by executing the imaging for control in step S12 is not displayed on the liquid crystal display device 13.

In the next step S13, an AE process is performed so that the diaphragm position of the diaphragm mechanism in the lens unit 1, the shutter speed of the shutter mechanism 2, and the electronic shutter speed set in the timing signal generation circuit 6 are determined, thereby performing exposure control.

In the next step S14, a color balance measuring operation is performed in an AWB process, and based on the results of the operation, the amplification ratio of the amplification circuit of each color in the AD conversion circuit 4 is controlled, thereby controlling the color balance.

In the next step S15, imaging for obtaining an image for capture is performed, and image data having controlled exposure and color balance is stored in the memory 14.

Next, due to the above-described YC conversion executed by the image processing circuit 9, the image data in the memory 14 is converted into the brightness (Y) element and color (Cr and Cb) elements (see step S16). The converted data is subjected to JPEG compression through an image compressing process (see step S17), and stored in the memory card 16 through an image storing process (see step S18). Furthermore, an image display process for displaying the obtained image onto the liquid crystal display device 13 is performed (see step S119).

The operation from YC conversion in step S16 to the image display process in step S19 is a known process commonly used in digital cameras; thus, a detailed explanation thereof is omitted here.

The AE/AWB preprocess will be explained with reference to FIG. 5. In the AE/AWB preprocess in FIG. 5, the area and position of image data used for operation are designated. As shown in FIGS. 3 and 4, this preprocess is executed in the initial stages (i.e., in step S1 and step S11) of the finder operation and the capture operation.

In FIG. 5, in the AE/AWB preprocess, it is first determined whether the electronic zoom state is presently active (see step S21). If in the electronic zoom state, the evaluation mode is determined (see step S22).

In step S22, when the evaluation mode is the zoom area preference evaluation mode, the area assigned to the image data is designated by a sampling area designation process performed in the zoom area preference evaluation mode (see step S23), and a sampling density designation process is also performed in this mode (see step S24), thereby determining the sampling state of the image data used for the relevant operation.

In step S22, when the evaluation mode is the whole area uniform evaluation mode, the area assigned to the image data is designated by a sampling area designation process performed in the whole area uniform evaluation mode (see step S25), and a sampling density designation process is also performed in this mode (see step S26), thereby determining the sampling state of the image data used for the relevant operation.

Also when it is determined in step S21 that the electronic zoom state is not presently active (i.e., a full-screen display state is active), the operation proceeds to the above step S25.

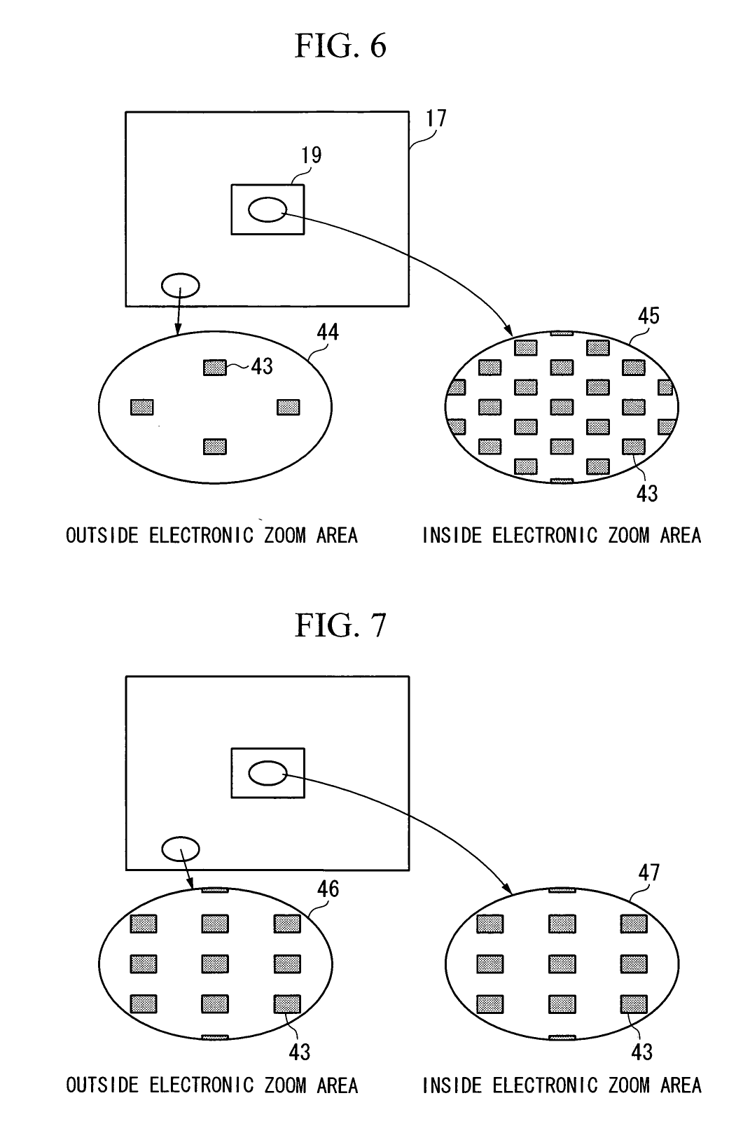

FIG. 6 shows a sampling state of image data for operation in the zoom area preference evaluation mode, and FIG. 7 shows a sampling state in the whole area uniform evaluation mode. This example employs a 3× zoom state, and the 3× zoom area 19 (see FIG. 2) is defined.

In FIGS. 6 and 7, each block indicated by reference numeral 43 may consist of 8×8 pixels. Note that the block configuration can be appropriately modified.

As shown in FIGS. 6 and 7, in the 3× zoom mode, the image in the zoom area 19 is extracted and enlarged by interpolation (refer to reference numerals 45 and 47). In this case, when in the zoom area preference evaluation mode, as shown in FIG. 6, the ratio of the number of target blocks in the sampling state outside the zoom area 19 (see reference numeral 44) to that in the sampling state inside the zoom area 19 (see reference numeral 45) is, for example, ¼.

In contrast, in the whole area uniform evaluation mode, as shown in FIG. 7, the sampling state inside the zoom area 19 (see reference numeral 47) is similar to the sampling state outside the zoom area 19 (see reference numeral 46).

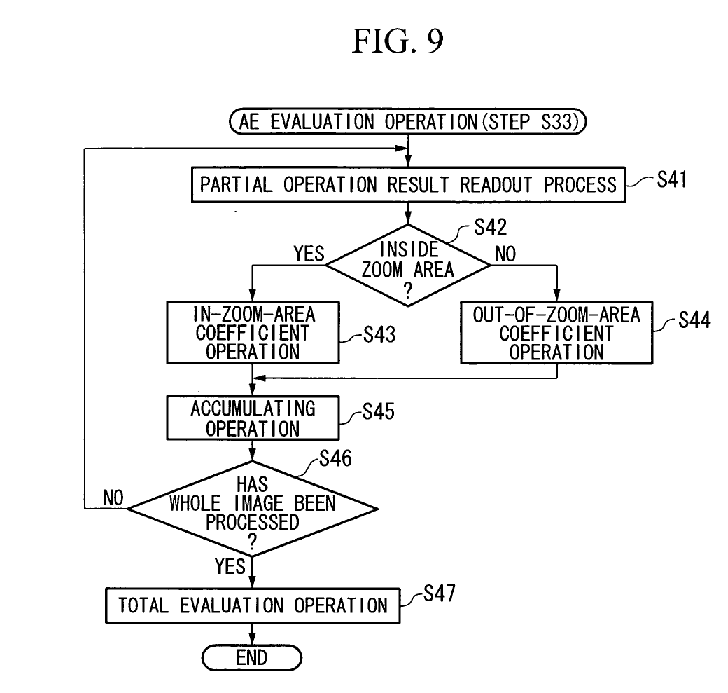

Below, the AE process performed in step S3 and step S13 will be explained with reference to FIGS. 8 and 9.

FIG. 8 is a flowchart showing the AE process. This AE process is executed in both the finder operation and the capture operation, so as to perform exposure control.

Regarding the AE process, after the sampling state is designated in the AE/AWB preprocess shown in FIG. 5, and a specific operation is applied to the whole image by the AE operation circuit 8, an evaluation operation is executed using the result of the above specific operation, so as to obtain control values relating to exposure control, thereby controlling the diaphragm position of the diaphragm mechanism in the lens unit 1, the shutter speed of the shutter mechanism 2, and the electronic shutter speed set by the timing signal generation circuit 6 and thus controlling the quantity of light on the imaging device 3.

In the AE process shown in FIG. 8, first, it is determined whether the electronic zoom state is presently active (see step S31). If the electronic zoom state is active, the evaluation mode in the electronic zoom state is determined (see step S32). When it is determined in step 32 that the zoom area preference evaluation mode is presently active, an AE evaluation operation in the zoom area preference evaluation mode is executed (see step S33). On the other hand, if it is determined that the whole area uniform evaluation mode is presently active, an AE evaluation operation in the whole area uniform evaluation mode is executed (see step S34).

In addition, when it is determined in the above step S31 that the electronic zoom state is not presently active (i.e., a full-screen display state is active), the operation also proceeds to the above step S34.

During the AE evaluation operation, an operation for evaluation is performed using data of both the inside and the outside of the zoom area, either in the zoom area preference evaluation mode or the whole area uniform evaluation mode. However, as explained later, during the AE evaluation operation in the zoom area preference evaluation mode, a higher evaluation rate is applied to the inside of the zoom area, while during the AE evaluation operation in the whole area uniform evaluation mode, the overall image is uniformly evaluated.

After the AE evaluation operation in the zoom area preference evaluation mode or the whole area uniform evaluation mode is completed, the operation state is detected (see step S35).

During the finder operation, control of the position of the diaphragm, which is assigned to the finder operation, is performed (see step S36), but during the capture operation, control of the position of the diaphragm, which is assigned to the capture operation, is performed (see step S37).

During the diaphragm position control of the finder operation (in step S36), the diaphragm position in the lens unit 1 is maintained in a full-open state. The exposure control is executed using the control of the electronic shutter time (or period) of the imaging device 3, which is performed in the exposure time control in the next step S38. The shutter of the shutter mechanism 2 is maintained in the open state.

During the diaphragm position control of the capture operation (in step S37), the diaphragm position in the lens unit 1 is variable depending on a value obtained by the evaluation operation, and the exposure time is controlled in accordance with the control of the shutter speed of the shutter mechanism 2 performed in the exposure time control of the next step S39. In this process, the exposure time depending on the electronic shutter speed set by the timing signal generation circuit 6 is set longer than the exposure time determined by the shutter mechanism 2. Therefore, the exposure time is determined depending on the shutter mechanism 2.

As discussed above, in the AE process in FIG. 8, the evaluation mode is determined in step S32. When in the zoom area preference evaluation mode, the AE evaluation operation for the zoom area preference evaluation mode is executed in step S33, but in the whole area uniform evaluation mode, the AE evaluation operation for the whole area uniform evaluation mode is executed in step S34.

In the AE evaluation operation for the zoom area preference evaluation mode, executed in step S33, image data of both the inside and the outside of the zoom area is used for executing an evaluation operation for control; however, in evaluation, a higher evaluation rate is assigned to the inside of the zoom area, thereby performing control while giving priority to obtaining an appropriate exposure state inside the zoom area.

More specifically, as explained using FIG. 6, a higher sampling density is assigned to the image data inside the electronic zoom area; thus, the number of data items used for evaluation is large, thereby performing detailed evaluation. In addition, a value indicating a degree of influence on results of evaluation is set to (i) 2 for the inside of the zoom area, or (ii) 1 for the outside of the zoom area. These values are used for obtaining the results of evaluation. Such a ratio used for evaluation can be appropriately modified.

FIG. 9 is a flowchart showing the AE evaluation operation in the zoom area preference evaluation mode in step S33 in FIG. 8.

In FIG. 9, first, a partial operation result readout process is performed by reading out a result of operation for a sampling block from the AE operation circuit 8 (i.e., data readout is performed for each sampling block) (see step S41). After that, it is determined whether the position of the readout data is inside the zoom area (see step S42). When inside the zoom area, an in-zoom-area coefficient operation is performed (see step S43), while when outside the zoom area, an out-of-zoom-area coefficient operation is performed (see step S44). After the in-zoom-area coefficient operation in step S43 or the out-of-zoom-area coefficient operation in step S44 is performed, an accumulating operation is performed (see step S45).

Between the in-zoom-area coefficient operation and the out-of-zoom-area coefficient operation, the multiplication coefficient which is multiplied by the readout partial operation result is different. The multiplication coefficient is set in accordance with the sampling number, so that degrees “2” and “1” of influence on a result of the accumulating operation (in step S45) for accumulating output results of operation are respectively assigned to the inside and the outside of the zoom area (i.e., the ratio of the above degree of the inside of the zoom area to the outside of the zoom area is 2:1).

After it is determined whether the accumulating operation for accumulating results obtained by the in-zoom-area coefficient operation (in step S43) and the out-of-zoom-area coefficient operation (in step S44) is completed for the whole image (see step S46), a total evaluation operation is performed (see step S47). The operation of the present flow is then completed.

In the total evaluation operation in step S47, an evaluation operation for determining a control amount for exposure is executed by performing a comparison with a predetermined accumulation value, applied to a result of the accumulating operation.

That is, an operation result of the in-zoom-area coefficient operation in step S43 or the out-of-zoom-area coefficient operation in step S44 is obtained for each sampling block in the whole image, and operation results for all sampling blocks are added (i.e., accumulated) so as to obtain an accumulated value, which is compared with the predetermined accumulation value.

Such evaluation operation executed in the total evaluation operation is a commonly known technique relating to digital cameras; thus, a detailed explanation thereof is omitted.

Similar to the AE evaluation operation in the zoom area preference evaluation mode, the AE evaluation operation in the whole area uniform evaluation mode (performed in step S34) is applied to the image data of both the inside and the outside of the zoom area. However, during the AE evaluation operation in the whole area uniform evaluation mode, the whole effective pixel area is uniformly evaluated. That is, as explained above using FIG. 7, sampling of image data is performed with the same sampling density, regardless of the electronic zoom state, and evaluation is also performed using the same weight to be applied.

More specifically, in comparison with the flowchart in FIG. 9, the AE evaluation operation in the whole area uniform evaluation mode can be implemented by omitting the determination of the inside or the outside of the zoom area (see step S42 in FIG. 9) and providing the same coefficient to the in-zoom-area coefficient operation (see step S43) and the out-of-zoom-area coefficient operation (see step S44). Therefore, further explanation will be omitted.

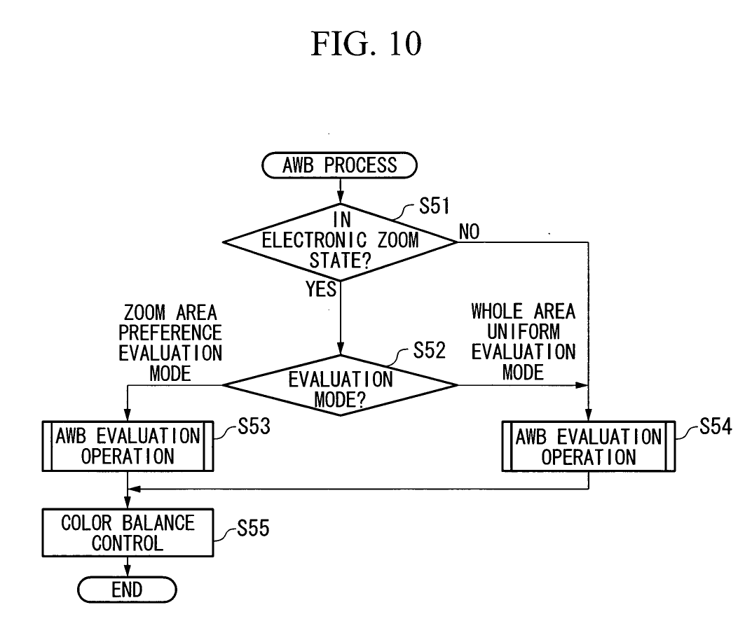

Next, the AWB process performed in step S4 in FIG. 3 or in step S14 in FIG. 4 will be explained with reference to FIG. 10.

The AWB process is a process for performing the color balance control, and is executed in both the finder operation and the capture operation.

Regarding the color balance control, after the sampling state is designated in the AE/AWB preprocess shown in FIG. 5 and a specific operation is applied to the whole image by the AWB AD conversion circuit 7, an evaluation operation is executed using the result of the above specific operation, so as to obtain control values relating to balance control for each color, thereby controlling the amplification ratio of the amplification circuit of each color in the AD conversion circuit 4 and thus controlling color balance of the image data output from the AD conversion circuit 4.

In the AWB process in FIG. 10, it is first determined whether the electronic zoom state is presently active (see step S51). If in the electronic zoom state, the evaluation mode in the electronic zoom state is determined (see step S52). When it is determined in step 52 that the zoom area preference evaluation mode is presently active, an AWB evaluation operation in the zoom area preference evaluation mode is executed (see step S53), while when it is determined that the whole area uniform evaluation mode is presently active, an AWB evaluation operation in the whole area uniform evaluation mode is executed (see step S54).

In addition, when it is determined in the above step S51 that the electronic zoom state is not presently active (i.e., a full-screen display state is active), the operation also proceeds to the above step S54.

In the AWB evaluation operation, an operation for evaluation is performed using data of both the inside and the outside of the zoom area, either in the zoom area preference evaluation mode or the whole area uniform evaluation mode. However, during the AWB evaluation operation in the zoom area preference evaluation mode, a higher evaluation rate is applied to the inside of the zoom area, while during the AWB evaluation operation in the whole area uniform evaluation mode, the overall image is uniformly evaluated. After the AWB evaluation operation in the zoom area preference evaluation mode or the whole area uniform evaluation mode is completed, the amplification ratio of the amplification circuit of each color is controlled based on a value obtained by the evaluation, thereby controlling the color balance (see step S55).

As discussed above, in the AWB evaluation operation for the zoom area preference evaluation mode which is executed in step S53, image data of both the inside and the outside of the zoom area is used for executing an evaluation operation for control; however, in evaluation, a higher evaluation rate is assigned to the inside of the zoom area, thereby performing control while giving priority to obtaining an appropriate color balance state inside the zoom area.

More specifically, as explained using FIG. 6, a higher sampling density is assigned to the image data inside the electronic zoom area; thus, the number of data items used for evaluation is large, thereby performing detailed evaluation. In addition, a value indicating a degree of influence on results of evaluation is set to (i) 2 for the inside of the zoom area, or (ii) 1 for the outside of the zoom area. These values are used for obtaining the results of evaluation, and such a ratio used for evaluation can be appropriately modified. Additionally, a detailed evaluation operation method for the color balance control is known; thus, a detailed explanation of this evaluation operation is omitted here.

During the AWB evaluation operation in the whole area uniform evaluation mode (in step S54), an operation for evaluation is performed using image data of both the inside and the outside of the zoom area, similar to the AWB evaluation operation in the zoom area preference evaluation mode (in step S53); however, during evaluation in step S54, the whole effective pixel area is uniformly evaluated. That is, as explained above using FIG. 7, sampling of image data is performed with the same sampling density, regardless of the electronic zoom state, and evaluation is also performed using the same weight to be applied.

In accordance with the above-described operation, in the imaging apparatus having the electronic zoom function and storing all image data obtained by imaging (regardless of the ON/OFF state of the electronic zoom function), exposure and color balance control can be performed in desired states in accordance with a state of the electronic zooming and designation of the operator (i.e., photographer) of the imaging apparatus.

### Second Embodiment

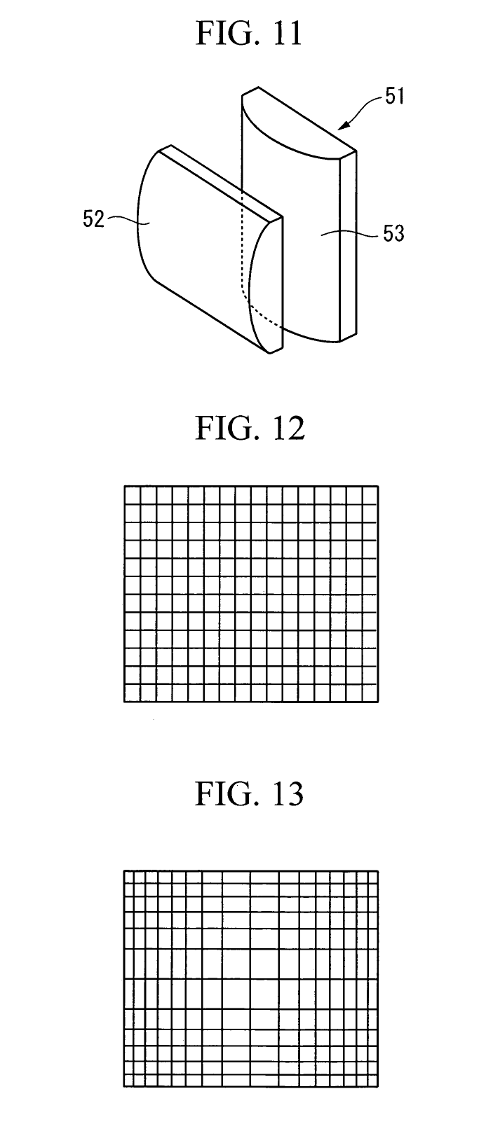

A second embodiment of the present invention will be explained below. The second embodiment employs an imaging apparatus having no electronic zoom function, in which a distortion lens unit 51 is provided in the optical system (instead of the lens unit 1 in the first embodiment). The distortion lens unit 51 has a combination of two cylindrical lenses 52 and 53 (see FIG. 11), and thus has a characteristic of condensing light while compressing a peripheral portion thereof. The basic structure other than the lens unit is similar to that in the first embodiment.

Also in this embodiment, a light quantity correction process is performed so as to correct variation in the quantity of received light due to the distortion lens unit 51, thereby performing exposure control in consideration of variation in the quantity of received light.

Furthermore, in the present embodiment, so that the setting for exposure is changeable, two photographing modes are defined: one is a person mode for performing control while giving priority to the exposure state of a central area, and the other is a night-view mode for performing control while giving priority to suppression of overexposure in consideration not only of a central area but also of a peripheral area.

FIGS. 12 and 13 are diagrams for explaining characteristics of the distortion lens unit 51 shown in FIG. 11. A picture (as the subject) shown in FIG. 11, which has sections divided at regular intervals, is projected through the distortion lens unit 51 onto a light reception plane of the imaging device 3, as a picture having wider spacing in a central area and narrower spacing in a peripheral area, as shown in FIG. 13. As a result, the quantity of received light is large in the peripheral area, and small in the central area.

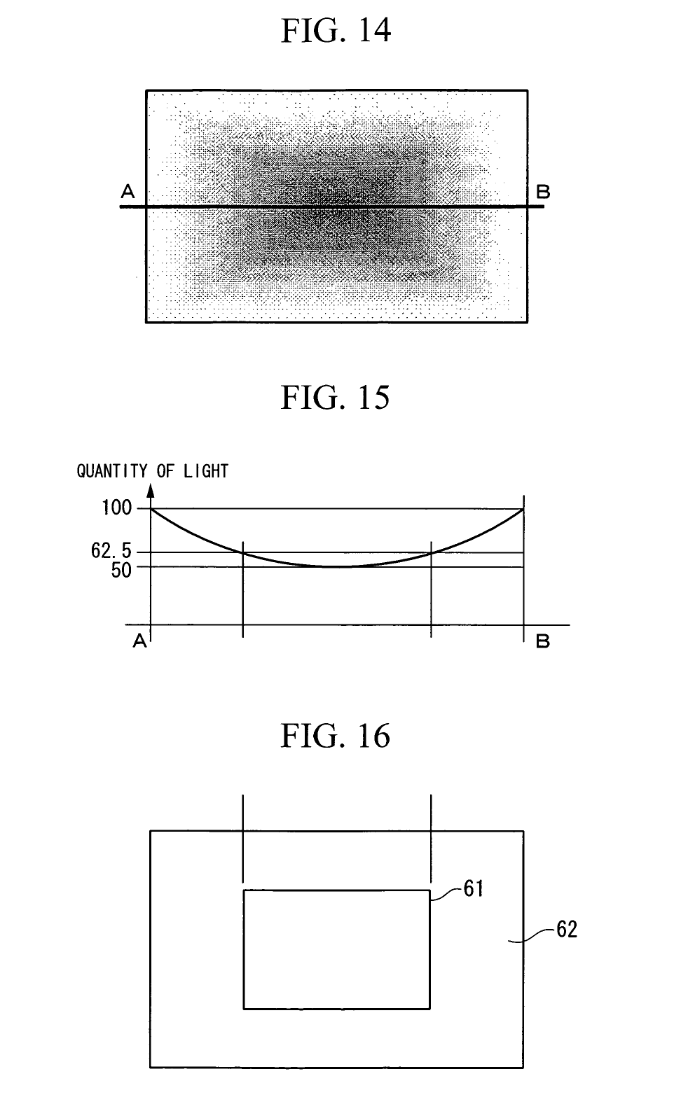

The state of the quantity of received light will be explained with reference to FIGS. 14 and 15. FIG. 14 shows a distribution of the quantity of light on the light reception plane when uniform light is received, and shows a state in which the quantity of received light reduces while going from a peripheral area to a central area.

FIG. 15 shows a distribution of the quantity of (received) light along line A-B in FIG. 14. As shown in FIG. 15, the quantity of received light is small in the central area, and large in the peripheral area.

As is known, distribution of the quantity of light is determined depending on the lens design, and various distribution states are possible. FIG. 15 shows an example in which the ratio of received light of the peripheral area to the central area is approximately 2:1. In the present embodiment, the evaluation operation for exposure control may be performed while dividing (or sectioning) the whole area based on the quantity of received light, or without performing such an area division.

FIG. 16 shows an example of the area division based on the quantity of received light. As shown in FIG. 16, the whole area is divided into two areas based on the quantity of received light. In FIG. 16, the quantity of received light is small in a central area 61, while the quantity of received light is large in a peripheral area 62. In this example, the boundary of the two areas is set to a quantity of 62.5% of received light (i.e., ⅝); however, the standard for dividing the area may be changed.

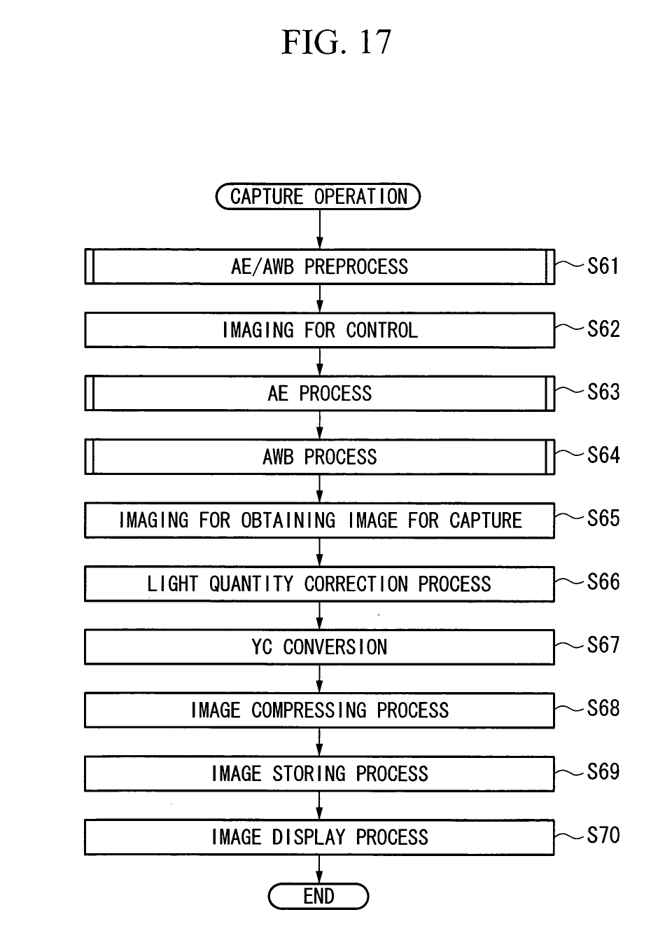

FIG. 17 is a flowchart showing the capture operation in the second embodiment. In the capture operation of this embodiment, a process relating to the distortion lens unit 51 is added to the capture operation of the first embodiment shown in FIG. 4.

In FIG. 17, immediately after the capture operation is started, an AE/AWB preprocess is performed (see step S61). Similar to the first embodiment, in the AE/AWB preprocess in step S61, the area and position of image data used in the following operation are designated. In the designation of the position, a zoom area is used in the first embodiment; however, in the present embodiment, area division is performed based on the quantity of received light as shown in FIG. 16.

After imaging for control is performed in the next step S62, an AE process is performed (see step S63). In the AE process in step S63, an evaluation operation is performed in accordance with the operation mode, and based on the result of the evaluation, exposure control is performed in accordance with the operation mode, by appropriately using the diaphragm position of the diaphragm mechanism in the distortion lens unit 51, the shutter speed of the shutter mechanism 2, and the electronic shutter speed set by the timing signal generation circuit 6. This process is similar to that performed in the first embodiment.

Next, an AWB process is performed (see step S64), and based on the result of an AWB operation in this process, the amplification ratio of the amplification circuit for each color in the AD conversion circuit 4 is controlled, thereby controlling color balance. This AWB process is identical to that performed in the first embodiment, except for setting of the data area, used for the evaluation operation.

In the next step S65, imaging for the capture operation is performed, and image data, to which exposure and color balance control has been applied, is stored in the memory 14. Next, a light quantity correction process is performed so as to correct variation in the quantity of received light on the imaging device 3, due to optical characteristics of the distortion lens unit 51 (see step S66). In the light quantity correction process, a variation in the quantity of received light is cancelled due to an operation executed by the image processing circuit 9. Specifically, image data stored in the memory 14 is read out and input into the image processing circuit 9, and is subjected to the operation for canceling such a variation, and the processed data is again stored in the memory 14.

In the light quantity correction process in step S66, the correction method is switched in accordance with the operation mode. This is because, as described above, in the person mode of exposure control, priority is given to the exposure state of a central area. Therefore, an amplification ratio “1” is assigned to a point in the central area, which has the smallest quantity of (received) light, while reducing amplification ratios assigned to the peripheral area (i.e., assigning values of 1 or smaller, depending on a variation in the quantity of light). Accordingly, correction of the quantity of light is performed based on the state of the central area where exposure control is appropriately performed.

In contrast, in the night-view mode, exposure control is performed based on a peak quantity of light, regardless of the type of area (i.e., central or peripheral area). Therefore, when light points having the same brightness are dispersed over the image, control is performed so as to provide an appropriate exposure to the peripheral area which has a larger quantity of received light. Accordingly, an amplification ratio value of “1” is assigned to a point in the peripheral area, which has the largest quantity of light, while increasing amplification ratios assigned to the central area. In this case, the central area has a relatively small quantity of received light; thus, no saturation occurs in the amplification process.

In the next step S67, YC conversion is performed, and then an image compressing process (see step S68) and an image storing process (see step S69) are performed. Then an image display process is performed (see step S70).

The operation from YC conversion in step S67 to the image display process in step S69 is similar to that in the first embodiment; thus, an explanation thereof is omitted here.

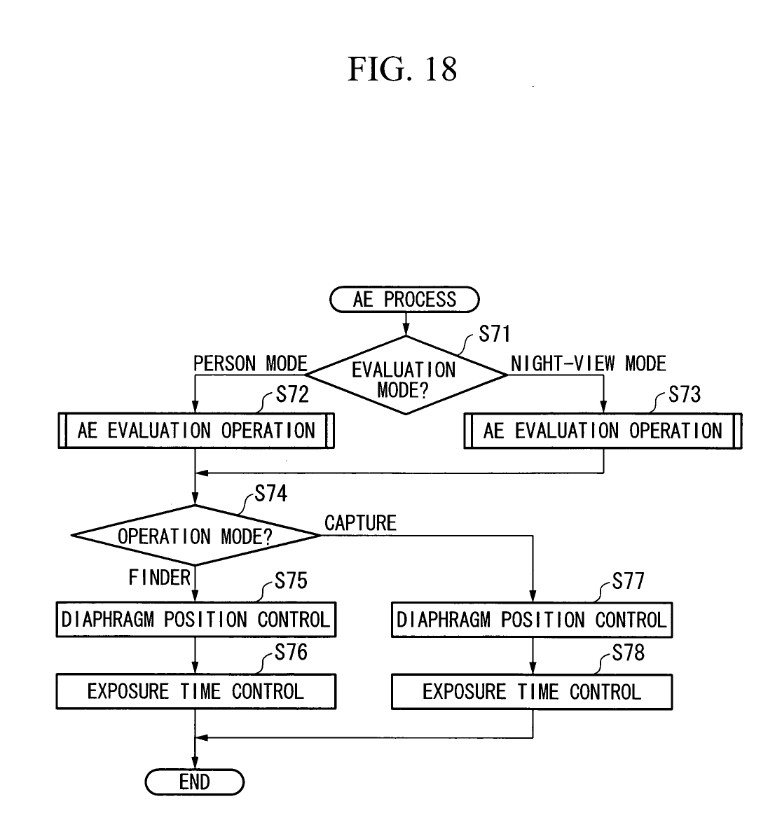

FIG. 18 is a flowchart showing the AE process in step S63, executed in both the finder and capture operations, so as to perform exposure control.

Regarding the AE process, after the sampling state is designated in the AE/AWB preprocess in step S61 in FIG. 17, and a specific operation is applied to the whole image by the AE operation circuit 8, an evaluation operation is executed using the result of the above specific operation, so as to obtain control values relating to exposure control, thereby controlling the diaphragm position in the diaphragm mechanism of the distortion lens unit 51, the shutter speed of the shutter mechanism 2, and the electronic shutter speed set in the timing signal generation circuit 6 and thus controlling the quantity of light on the imaging device 3.

In the AE process, it is first determined whether the photographing mode is the person mode or the night-view mode (see step S71). When in the person mode, an AE evaluation operation for the person mode is executed (see step S72), while when in the night-view mode, an AE evaluation operation for the night-view mode is executed (see step S73).

During the AE evaluation operation for the person mode in step S72, although the evaluation operation for the exposure control is performed using image data of both the central and peripheral areas, a higher evaluation rate is assigned to the peripheral area so as to perform control while priority is given to obtaining an appropriate exposure state of the peripheral area. During the AE evaluation operation for the night-view mode in step S73, a bright point having an area larger than a specific value is detected (i.e., a peak value is detected).

After the AE evaluation operation for the person mode in step S72 or the AE evaluation operation for the night-view mode in step S73 is completed, the operation mode is determined (see step S74). During the finder operation, diaphragm position control (see step S75) and exposure time control (see step S76) are performed. In step S74, when during the capture operation, diaphragm position control (see step S77) and exposure time control (see step S78) are performed.

The operation of this flowchart is then completed. The capture operation and the diaphragm are similar to those in the first embodiment; thus, an explanation thereof is omitted.

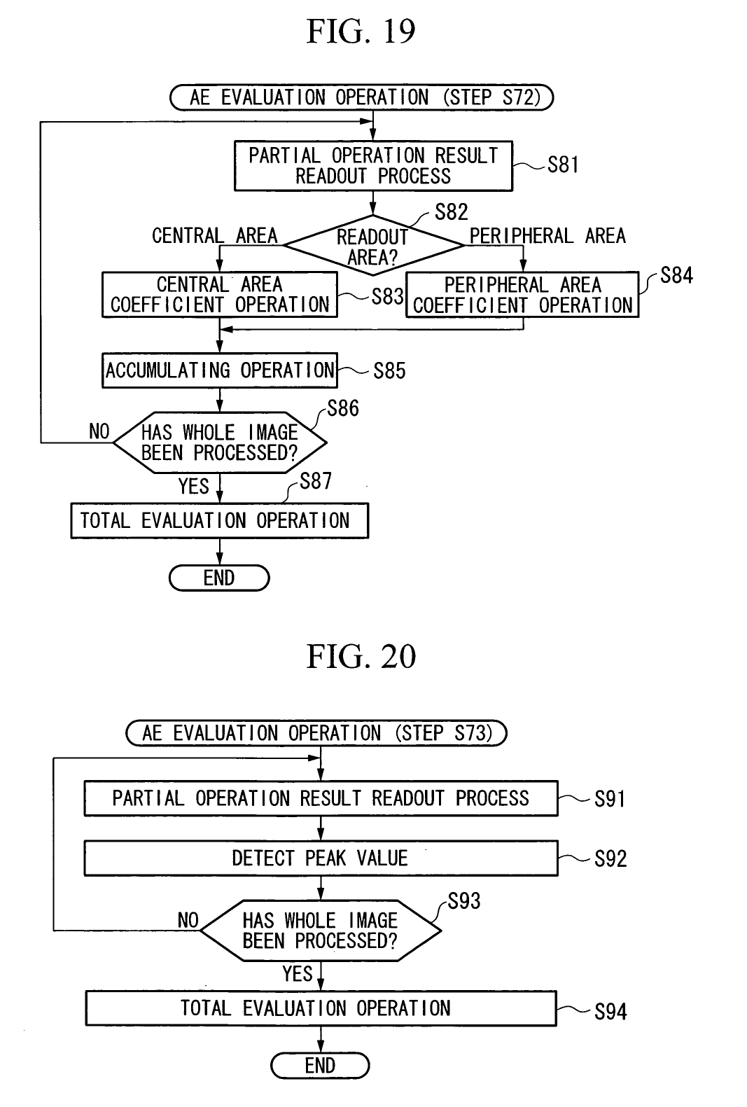

FIG. 19 is a flowchart showing the AE evaluation operation for the person mode, performed in step S72.

During the AE evaluation operation, a partial operation result readout process is performed by reading out the result of an operation on a sampling block from the AE operation circuit 8 (i.e., data readout is performed for each sampling block) (see step S81). After that, determination of the position of the readout data is performed (see step S82). When it is determined in step S82 that the data belongs to the central area, a central area coefficient operation is performed (see step S83), but if it is determined that the data belongs to the peripheral area, a peripheral area coefficient operation is performed (see step S84).

Between the central area coefficient operation in S83 and the peripheral area coefficient operation in step S84, the multiplication coefficient which is multiplied by the readout partial operation result is different. The multiplication coefficient is set in accordance with the number of sampling blocks, so that degrees “2” and “1” of influence on a result of the accumulating operation (in step S85) for accumulating output results of operation are respectively assigned to the central area and the peripheral area (i.e., the ratio of the above degree of the central area to the peripheral area is 2:1).

After it is determined whether the accumulating operation for accumulating results obtained by the in-zoom-area coefficient operation (in step S83) and the out-of-zoom-area coefficient operation (in step S84) is completed for the whole image (see step S86), a total evaluation operation is performed (see step S87). The operation of the present flowchart is then completed.

Similar to the first embodiment, during the total evaluation operation in step S87, an evaluation operation for determining a control amount for exposure is executed by performing a comparison with a predetermined accumulation value, applied to the result of the accumulating operation.

That is, the operation result of the central area coefficient operation in step S83 or the peripheral area coefficient operation in step S84 is obtained for each sampling block in the whole image, and operation results for all sampling blocks are added (i.e., accumulated) so as to obtain an accumulated value, which is compared with the predetermined accumulation value.

In contrast with the first embodiment, the present embodiment has two photographing modes, and during the AE evaluation operation, an operation using the peak quantity of light is performed as an evaluation method for exposure control in the night-view mode.

FIG. 20 is a flowchart of the AE evaluation operation for the night-view mode, performed in step S73.

In FIG. 20, during the AE evaluation operation for the night-view mode, a partial operation result readout process is performed by reading out the result of operation for a sampling block from the AE operation circuit 8 (i.e., data readout is performed for each sampling block) (see step S91). After that, detection of the peak value is performed (see step S92), that is, detection of a bright point having an area larger than a specific value (i.e., detection of a peak value) is performed. After all sample blocks of the whole image are checked (see step S93), a total evaluation operation is performed (see step S94).

In the total evaluation operation in step S94, exposure of the bright point having the highest brightness in the whole image is measured.

Based on the exposure of the bright point measured in the AE evaluation operation for the night-view mode, control for setting the exposure of each bright point to a specific value is performed through the diaphragm position control (step S75 or S77) and the exposure time control (step S76 or S78).

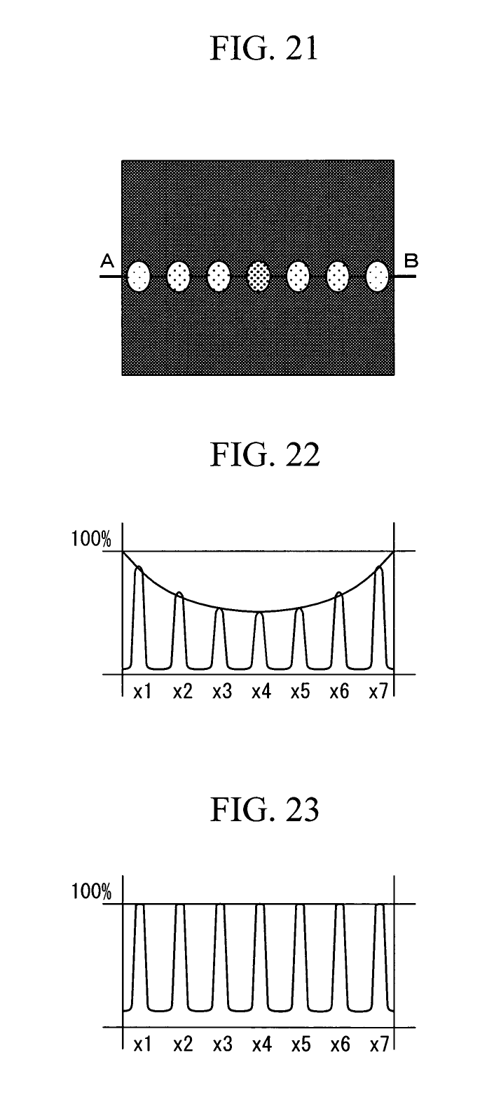

Next, exposure control in the night-view mode will be further explained with reference to FIGS. 21 to 25.

FIG. 21 shows a light reception state on the imaging device when a picture, which includes light points having the same quantity of light which are horizontally aligned with a dark background, is photographed after exposure control.

FIG. 22 shows outputs (of the imaging device) along line A-B in FIG. 21, obtained by photographing in the night-view mode. In the night-view mode, control for making the peak value correspond to a specific quantity of light is performed; thus, exposure is controlled so as to set the image data outputs at the peripheral positions (x1 and x7 in FIG. 22) to specific values.

FIG. 23 shows outputs (of the imaging device) along line A-B in FIG. 21, obtained by photographing in the person mode. In the person mode, control for setting the average quantity of light to a specific value is performed. Therefore, when photographing a picture as shown in FIG. 21, exposure is increased due to the presence of the dark background, thereby increasing the exposure to a level at which the light points are saturated.

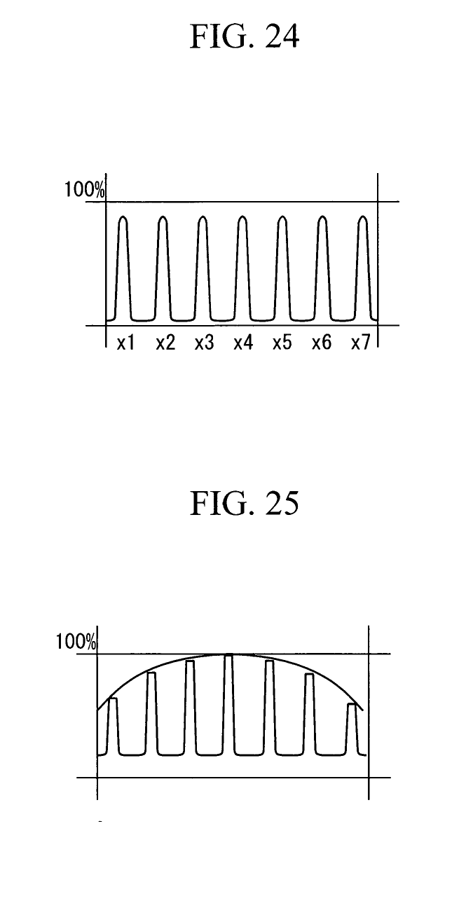

FIG. 24 shows data output levels after the correction of the quantity of light for the night-view mode. In the night-view mode, a process of increasing the gain (output) as approaching the central area is performed based on the quantity of light of the peripheral area; thus, an appropriate image can be obtained as shown in FIG. 24.

FIG. 25 shows data output levels after the correction of the quantity of light for the person mode. In the person mode, a process of decreasing the gain as approaching the peripheral area is performed based on the quantity of light of the central area; thus, as shown in FIG. 25, brightness of the light points in the peripheral area is decreased, thereby obtaining an image having an inappropriate exposure state.

Due to the night-view mode of the present embodiment, even when photographing a picture as shown in FIG. 21, an appropriate exposure state can be obtained.

### Third Embodiment

This embodiment employs an imaging apparatus which has a distortion lens unit 51 similar to that in the second embodiment and has an electronic zoom function similar to the first embodiment.

In the present embodiment, in a process corresponding to the process for the person mode in the second embodiment, area division (to a central area and a peripheral area) based on the quantity of light is not performed, and instead, area division with respect to the inside and the outside of the zoom area in the electronic zoom state is performed. Accordingly, in contrast with the second embodiment in which exposure control is performed with priority given to the central area in the person mode, in the present embodiment, the inside of the electronic zoom is given priority; thus, also in an imaging process using the electronic zoom function in the imaging apparatus having the distortion lens unit 51, exposure control for giving priority to the zoom area which includes the main subject can be performed.

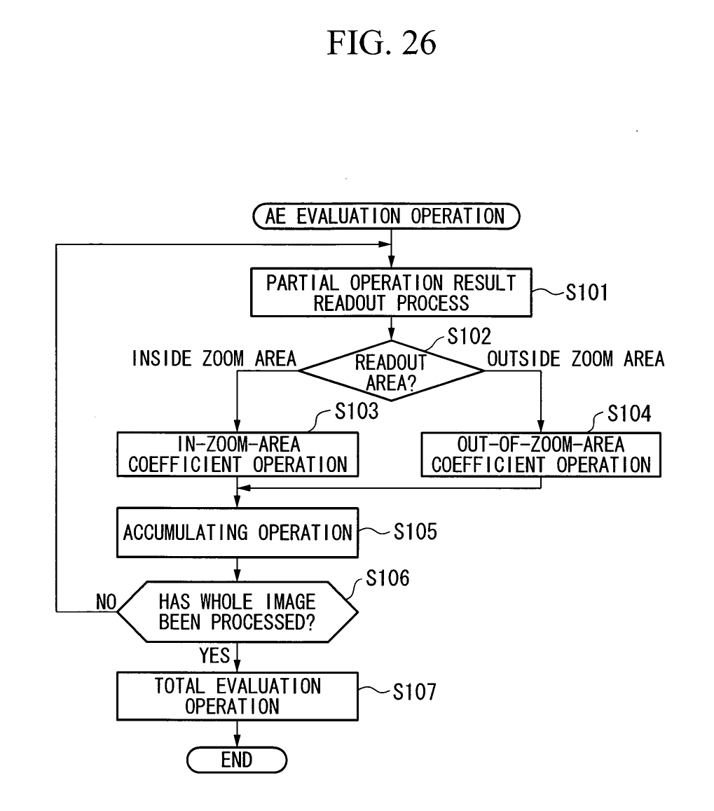

The exposure control for the person mode in the present embodiment will be explained with reference to FIG. 26.

The flowchart showing the AE evaluation operation in FIG. 26 corresponds to the flowchart showing the AE evaluation operation in FIG. 19 in the second embodiment.

In the AE evaluation operation in FIG. 26, a partial operation result readout process is performed by reading out a result of operation for a sampling block from the AE operation circuit 8 (i.e., data readout is performed for each sampling block) (see step S101). After that, determination of the position of the readout data is performed (see step S102).

When the data position is inside the zoom area, an in-zoom-area coefficient operation is performed (see step S103), but when the data position is outside the zoom area, an out-of-zoom-area coefficient operation is performed (see step S104).

In the present embodiment, a high-density sampling block arrangement is assigned to the inside of the zoom area, while a low-density sampling block arrangement is assigned to the outside of the zoom area. Between the in-zoom-area coefficient operation in S103 and the out-of-zoom-area coefficient operation in step S104, the multiplication coefficient which is multiplied by the readout partial operation result is different. The multiplication coefficient is set to a desired value in accordance with the zoom ratio, and is computed in accordance with the number of sampling blocks used for the operation (for example, in 2× zoom, (2:1) for the inside to the outside of the zoom area, and in 3× zoom, (3:1) for the inside to the outside of the zoom area).

After it is determined whether the accumulating operation for accumulating results obtained by the in-zoom-area coefficient operation (in step S103) and the out-of-zoom-area coefficient operation (in step S104) (that is, the accumulating operation for accumulating results of operation of each sampling block in turn) is completed for the whole image (see step S106), a total evaluation operation is performed (see step S107). The operation of the present flowchart is then completed.

In accordance with the above operation, exposure operation applied to divided process areas such as the inside and the outside of the zoom area is performed, and similar to the second embodiment, based on results of the operation, exposure control is performed due to control of the diaphragm position of the diaphragm mechanism in the distortion lens unit 51, the shutter speed of the shutter mechanism 2, and the electronic shutter speed set by the timing signal generation circuit 6. Portions other than those explained above are identical to those of the second embodiment; thus, an explanation thereof is omitted.

The present invention is not limited to the above-described embodiments, and modifications or applications within the gist of the present invention are possible.

In accordance with the present invention, operation of parameters used for exposure and color balance control is performed using image data not only inside the electronic zoom area (i.e., the first image area) but also outside the zoom area (i.e., the second image area), and in the parameter operation, a larger evaluation coefficient value to be multiplied by the image data is assigned to the inside of the zoom area, thereby performing exposure and color balance control while giving priority to (the exposure and color balance control of) the inside of the zoom area which probably includes the main subject to be photographed, while simultaneously considering the outside of the zoom area which may be used in a trimming process after imaging.

In addition, data inside the electronic zoom area is used more in comparison with the outside of the zoom area. This improves the measurement accuracy of the inside of the zoom area which is highly reflected in the control, thereby performing control having a necessary accuracy within a minimum processing time.

Furthermore, if photographing a scene or view in which a main subject is not fixed, when the photographer determines that trimming will be probably performed, exposure and color balance control with respect to the whole output image can be performed regardless of the electronic zoom state, due to the operation of the photographer. Therefore, occurrence of problems in the trimming process after the storage of image data can be avoided. Additionally, in photographing, selection depending on the possibility of the future trimming process can be performed, thereby improving convenience to the photographer.

On the other hand, in the exposure control of the imaging apparatus having a distortion optical system, combination of the contents of the exposure operation and the light quantity correction for correcting light-condensing characteristics of the optical system is determined in accordance with the photographing mode; thus, exposure control in accordance with the employed correction of the quantity of light is performed, thereby improving the quality of the obtained image.

In this case, for imaging of a picture having a main image in a central area, such as when photographing a person or the like, the person mode is provided. By measuring the quantity of light based on an average exposure, the exposure of the central area which includes the main subject is appropriately controlled. In addition, in the operation of brightness correction, image data of the peripheral area having an increased quantity of light is controlled based on the quantity of light of the central area. Therefore, imaging optimized for the main subject can be performed,

On the other hand, the night-view mode is also provided for photographing a scene in which, typically, bright portions are dispersed with a dark background. In a distortion optical system, the difference between the quantities of light of central and peripheral areas is large. Therefore, when photographing an image in which bright portions are dispersed with a dark background (e.g., a night view), if exposure for saturating bright points is performed, lightness of the bright points is not uniform due to the operation of brightness correction, thereby obtaining an unnatural image. In the night-view mode, exposure control is performed using the peak quantity of light in the peripheral area, thereby preventing saturation of the peripheral area due to increase of the exposure time.

Also in the brightness correction operation, a higher gain is assigned to the central area based on the quantity of light of the peripheral area, thereby outputting an image including bright parts whose output values are near the saturation level. Therefore, high quality imaging can be performed.

Also in photographing in the electronic zoom state of an imaging apparatus having a distortion optical system, the person mode and the night-view mode may be provided as exposure modes. In the person mode, optimization of exposure and correction of brightness are performed so as to obtain an optimum image in the electronic zoom area. Therefore, control is performed so that the main subject in the electronic zoom area is imaged in an optimum state, thereby performing high quality imaging. In the night-view mode, the peak value of the exposure is reduced regardless of the electronic zoom area; thus, no overexposure area is generated. In addition, brightness correction is performed based on the outside of the zoom area having a smaller quantity of light; thus, no overexposure area is included in the obtained whole image, thereby performing high quality imaging.

The present invention can be applied to exposure control or color balance control of digital still cameras or digital video cameras having an electronic zoom function, or digital still cameras or digital video cameras having a distortion lens unit.

What is claimed is:

1. An imaging apparatus comprising:
an imaging device outputting original image data;
an electronic zoom device for subjecting data of a predetermined first image area among the original image data to electronic zooming;
a parameter operation circuit for respectively multiplying evaluation coefficients by image data belonging to the first image area and image data belonging to a second image area other than the first image area with respect to the original image data, so as to compute a parameter used for at least one of exposure control and color balance control; and
a control circuit for applying a zoom area preference evaluation mode to the parameter operation circuit, so as to set the evaluation coefficient assigned to the first image area to a larger value in comparison with the evaluation coefficient assigned to the second image area.

2. The imaging apparatus in accordance with claim 1, wherein the control circuit controls the parameter operation circuit so that a larger number of image data items is obtained by sampling of the first image area in comparison with the number of image data items obtained by sampling of the second image area.

3. The imaging apparatus in accordance with claim 1, wherein:
the control circuit can apply a whole area uniform evaluation mode to the parameter operation circuit, so as to set the evaluation coefficients assigned to the first image area and the second image area to substantially the same value; and
either of the whole area uniform evaluation mode or the zoom area preference evaluation mode is selectable.

4. An imaging apparatus comprising:
a distortion optical system having an optical characteristic for condensing light while compressing a peripheral area of a subject to be photographed in comparison with a central area of the subject.
an imaging device for converting an optical image obtained by imaging of the distortion optical system to image data;
a parameter operation circuit for performing an operation for computing a parameter used for exposure control with respect to the subject, based on the image data output from the imaging device and the optical characteristic of the distortion optical system;
an image processing circuit for subjecting the image data, which is obtained by imaging performed after the exposure control, to image processing in accordance with the optical characteristic, based on the computed parameter; and
a control circuit having a plurality of selectable exposure modes, and determining the operation executed by the parameter operation circuit and the image processing executed by the image processing circuit in accordance with the selected exposure mode.

5. The imaging apparatus in accordance with claim 4, wherein the control circuit has a person mode as one of the exposure modes, and when the person mode is selected:
the parameter operation circuit executes the operation for computing the parameter based on a first average exposure obtained using the image data belonging to the central area and a second average exposure obtained using the image data belonging to the peripheral area, while applying a larger weight to the first average exposure in comparison with the second average exposure; and
the image processing circuit executes the image processing of the image data belonging to the peripheral area, based on a quantity of received light of the central area.

6. The imaging apparatus in accordance with claim 4, wherein the control circuit has a night-view mode as one of the exposure modes, and when the night-view mode is selected:
the parameter operation circuit executes the operation for computing the parameter so as to set a peak quantity of received light with respect to the image data to a value within a predetermined range; and
the image processing circuit executes the image processing of the image data belonging to the central area, based on a quantity of received light of the peripheral area.

7. The imaging apparatus in accordance with claim 4, further comprising:
an electronic zoom device for subjecting data of a predetermined image area among the image data to electronic zooming, wherein:
the parameter operation circuit computes the parameter, in an electronic zoom operation mode, by multiplying a first evaluation coefficient by image data, which belongs to a first image area subjected to the electronic zooming, among the image data, and also multiplying a second evaluation coefficient smaller than the first evaluation coefficient by image data, which belongs to a second image area other than the first image area, among the image data;
the control circuit has a person mode and a night-view mode as the selectable exposure modes;
when the person mode is selected, the parameter operation circuit executes the electronic zoom operation mode, and the image processing circuit executes the image processing of the image data belonging to the peripheral area, based on a quantity of received light of the central area; and
when the night-view mode is selected, the parameter operation circuit executes the operation for computing the parameter so as to set a peak quantity of received light with respect to the image data to a value within a predetermined range, and the image processing circuit executes the image processing of the image data belonging to the central area, based on a quantity of received light of the peripheral area.
